(19) United States
(12) Patent Application Publication
(10) Pub. No.: US 2017/0341169 A1
(43) Pub. Date: Nov. 30, 2017

(54) Circular Saw Bracket

(71) Applicant: Steven C Jones, Indianapolis, IN (US)

(72) Inventor: Steven C Jones, Indianapolis, IN (US)

(21) Appl. No.: 15/605,653

(22) Filed: May 25, 2017

Related U.S. Application Data
(60) Provisional application No. 62/341,618, filed on May 25, 2016.

(51) Int. Cl. B23D 59/00; B25H 3/00; B23D 45/16

(52) U.S. Cl. CPC B23D 59/007; B23D 45/16; B25H 3/006

(57) ABSTRACT

The present invention is a circular saw holder. In an embodiment, the circular saw bracket is provided with a ledge protruding from the body of the bracket. The ledge is further provided with a lip. The configuration allows the upper blade guard of a circular saw to rest on the ledge, while the lip engages the inside surface of the blade guard, preventing the saw from falling off the bracket. In an embodiment, through holes in the body allow the bracket to be mounted to a surface using screws.

### CROSS-REFERENCE TO RELATED APPLICATION(S)

The present application claims priority to U.S. Provisional Patent Application No. 62/341,618 filed on May 25, 2016, entitled “Saw Hook Bracket” the entire disclosure of which is incorporated by reference herein.

### BACKGROUND OF THE INVENTION

### 1. Description of Related Art

While on a job site, tools need must be quickly accessible for workers such that time is not wasted finding and bringing tools to a work area. Additionally, tools must safely and securely stored when not in use. Power tools and their components are often expensive, and improper storage may lead to the tools being dropped to the ground. Dropped tools may be damaged, and repairs or replacements can be costly.

Furthermore, dropping tools can be dangerous. In a worst-case scenario, a sharp tool may drop onto a worker, causing severe injury. One tool often used on a job site is a circular saw. The circular saw is portable, but heavy and awkwardly shaped. This makes it difficult to store safely and securely.

Various attempts have been made to solve problems found in circular saw holders art. Among these are found in: U.S. Pat. No. 4,406,064 Duke W. Goss; U.S. Pat. No. 5,205,422 to Kenneth D. Morris; and U.S. Pat. No. 5,833,185 to Carl E. Bradley. This prior art is representative of circular saw holders.

However, the prior art circular saw holders seem to be lacking in one way or another. The Goss patent, only uses a single nail to engage a hook to hang the circular saw. This method is unsecure, and a slight bump or shake could cause the saw to fall from the nail.

The Morris patent may provide a secure method of holding a circular saw, however the apparatus is bulky, and cannot be easily fixed to a work saddle or temporary work space. Furthermore, the design of the Morris patent does not provide a universal fit for all circular saws, as the distance between shoe hook and blade aperture do not allow all circular saw designs to fit in the holder. The holder may require adjustment for each circular saw design, which will be inconvenience if a work crew is using multiple saw designs at a job site.

The Bradley patent, provides a compact solution where a lever is created to hold a circular saw by the shoe. However, this holder is very insecure, and a slight bump or shake can cause the circular saw to come loose from the holder. Furthermore, the torque on the shoe of the circular saw can cause the shoe to become bent out of shape.

Based on the foregoing, there is a need in the art for a compact circular saw holder which can safely and securely hold all circular saw designs.

### SUMMARY OF THE INVENTION

In an embodiment, the present invention is a circular saw bracket adapted to securely hang a circular saw. In the embodiment, the circular saw bracket is provided with a body. A ledge protrudes outwardly from the body, and a lip protrudes upwardly from the end of the ledge.

In an embodiment, the circular saw bracket is configured, such that the upper fixed guard of a circular saw is placed onto the ledge, and the lip contacts the inside surface of the upper guard to prevent the circular saw from falling off the bracket.

In an embodiment, the body of the circular saw bracket is further provided with one or more through holes. The through holes are provided to accept screws which allow the circular saw bracket to be fixed to a secure surface.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a perspective view of the circular saw bracket, according to an embodiment of the present invention;

FIG. 2 is a left side elevational view of the circular saw bracket, according to an embodiment of the present invention;

FIG. 3 is a perspective view of the circular saw bracket in use, according to an embodiment of the present invention; and

FIG. 4 is a perspective view of the circular saw bracket in use, according to an embodiment of the present invention.

### DETAILED DESCRIPTION OF PREFERRED EMBODIMENTS

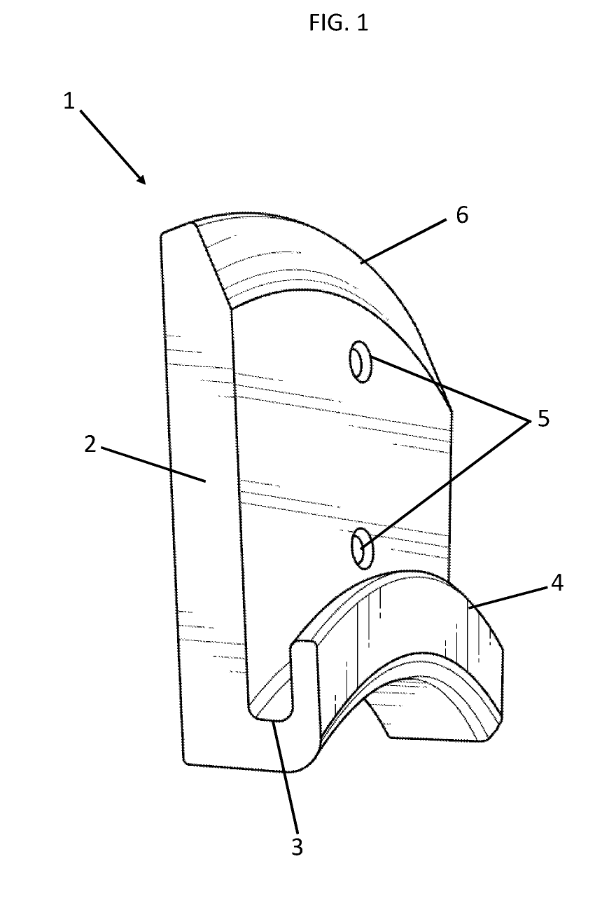

Preferred embodiments of the present invention and their advantages may be understood by referring to FIGS. 1-4, wherein like reference numerals refer to like elements.

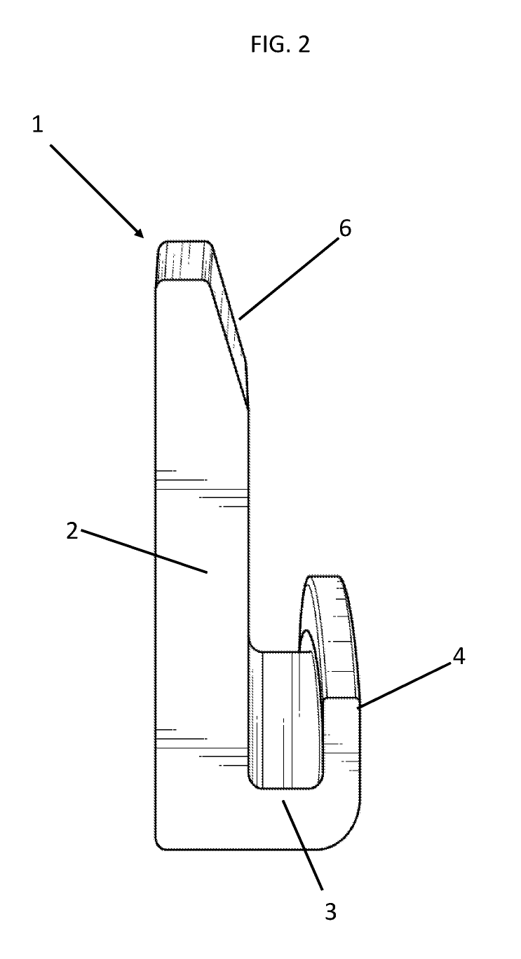

In reference to FIGS. 1-2, an embodiment of the circular saw bracket 1 is shown. In the embodiment, the bracket 1 is provided with a body 2. Extending from the body, a ledge 3 is provided with a lip 4. In the embodiment, the ledge 3 and lip 4 are provided to engage with the fixed upper blade guard (not shown) of a circular saw. In an embodiment, the lip 4 is adapted to fit in the space between the upper blade guard and the saw blade. Typically, this is the same space which is occupied by the retractable lower blade guard when the saw is in use.

In an exemplary embodiment, the bracket 1 is adapted to receive 7¼″ type circular saw. In the embodiment, the lip 4 is provided with a 3 8/16″ radius of curvature, the top of the ledge 3 is provided with a 2 13/16″ radius of curvature, and the bottom of the ledge 3 is provided with a 2½″ radius of curvature. In the embodiment, the body 2 is 9/16″ thick, 3 11/16″ tall, 2 9/16″ wide at the top with a 6″ radius of curvature, and 2″ wide at the bottom. The ledge 3 protrudes 9/16″ from the body 2. The lip 4 protrudes upwardly, 11/16″ from the top of the ledge 3, is provided 5/16″ away from the body 2, and has a thickness of a ¼″.

In an embodiment, the bracket has a total thickness of 1 3/16″, a bottom width of 2″, a top width of 2 9/16″, and a height of 3 11/16″.

In another embodiment, the dimensions of the bracket 1 may be altered as deemed necessary, or to accommodate circular saws of other sizes.

In an embodiment, the body 2 of the bracket is provided with a bevel 6, such that the circular saw may easily slide into the proper position when being hung onto the bracket.

In an embodiment, the body 2 of the bracket is further provided with mounting holes 5. The mounting holes are preferably countersunk, and are provided to accept screws to fix the bracket to a wall, saddle, or other suitable mounting surface. In another embodiment, the bracket may be mounted via adhesive, tape, welding, or other means.

In an embodiment, the bracket 1 is comprised of metal, such as steel or aluminum. However, the bracket may be comprised of other suitable materials such as plastic, ceramic, wood, etc.

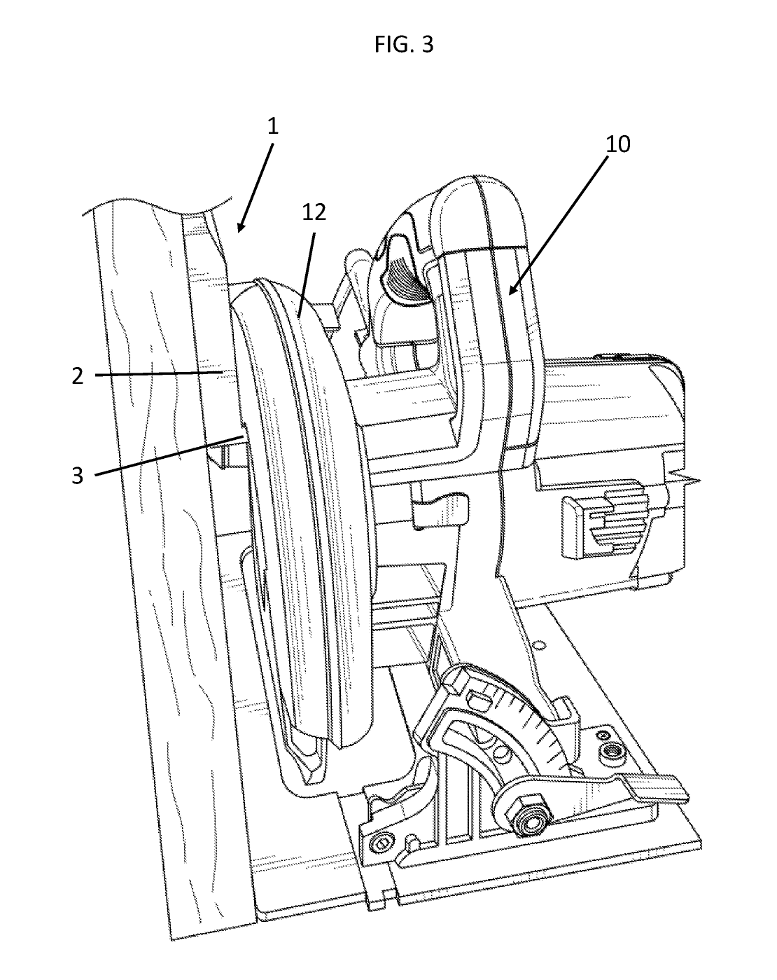

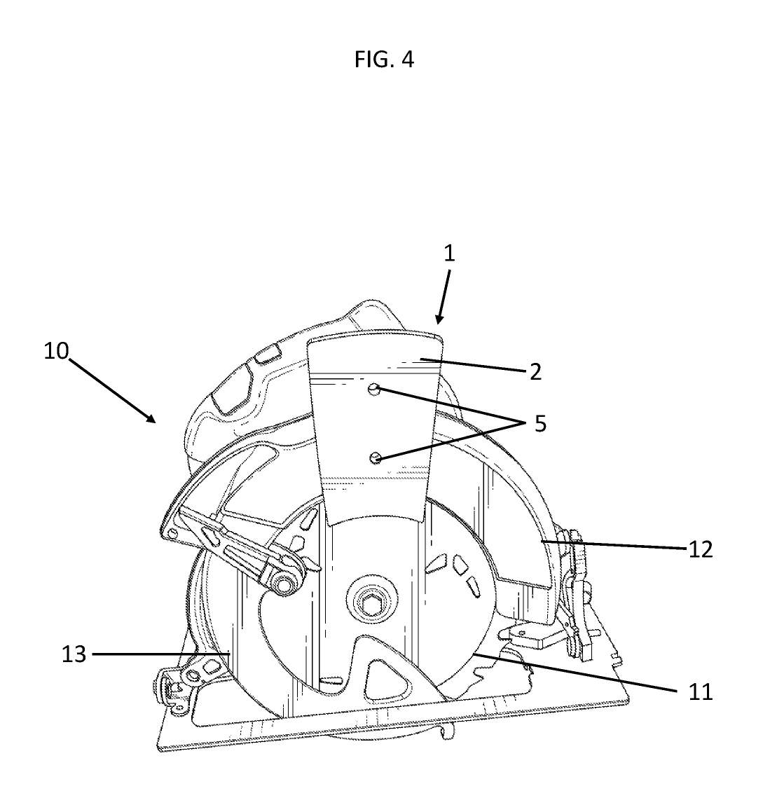

In reference to FIGS. 3-4, an embodiment of the bracket 1 is shown in use, wherein bracket is engaged with a circular saw 10. In the embodiment, the circular saw is placed onto the ledge, such that the saw is supported by upper blade guard 12 resting upon the top of the ledge 3. The lip (not shown) resides within the space between the fixed upper blade guard 12 and the blade 11, and contacts the inner wall of the upper blade guard 11 to prevent the saw from slipping off the bracket. The lip is adapted, such that it fits into the space where the lower blade guard 13 retracts into when the saw is in use.

In reference to FIG. 3, the bracket 1 has been mounted to a wood stud. In an embodiment, the wood stud may be part of a saddle or work station. In an embodiment, the bracket is mounted to the wood stud via screws which pass through the mounting holes provided in the body 2.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A circular saw bracket having:
a. a body;
b. a ledge, for engaging an upper blade guard of a circular saw, protruding outwardly from the body; and
c. a lip protruding upwardly from the ledge,
wherein the upper blade guard of a circular saw rests upon the ledge, and wherein the lip prevents engages an inside surface of the upper blade guard to prevent the circular saw from falling.

2. The circular saw bracket of claim 1, wherein the body is provided with one or more through holes to accept screws for mounting the bracket.

3. The circular saw bracket of claim 1, wherein the body is further provided with a bevel on a top edge of the body.

4. The circular saw bracket of claim 1, further having a means to fasten the circular saw bracket to a mounting surface.

5. The circular saw bracket of claim 2, further having a means to fasten the circular saw bracket to a mounting surface.

6. The circular saw bracket of claim 1, wherein the circular saw bracket is made of material consisting of the group selected from metal, polymer, wood, ceramic, carbon fiber, and combinations thereof.

7. The circular saw bracket of claim 1, wherein the lip is provided ¼″ to ⅜″ from the body.

8. The circular saw bracket of claim 1, wherein the lip is ⅛″ to ⅜″ thick.

9. A circular saw bracket having:
a. a first surface lying in a first plane;
b. a second surface, lying in a second plane parallel to the first plane, overlapping the first surface, said second surface defined by a segment of an annulus; and
c. a third surface, for disengageably supporting a circular saw, said third surface being disposed between the first surface and the second surface and defining an arc concentric with the annulus.

10. The circular saw bracket of claim 9, wherein the first surface is provided with one or more through holes.

11. The circular saw bracket of claim 9, wherein the one or more through holes provide a means for fastening the circular saw bracket to a mounting surface.

12. The circular saw bracket of claim 10, wherein the one or more through holes provide a means for fastening the circular saw bracket to a mounting surface.

13. The circular saw bracket of claim 9, further having a means to fasten the circular saw bracket to a mounting surface.

14. The circular saw bracket of claim 10, further having a means to fasten the circular saw bracket to a mounting surface.

15. The circular saw bracket of claim 9, wherein the third surface is for engaging an upper blade guard of the circular saw.

16. The circular saw bracket of claim 9, wherein the circular saw bracket is made of material consisting of the group selected from metal, polymer, wood, ceramic, carbon fiber, and combinations thereof.

17. The circular saw bracket of claim 9, wherein the second surface is provided ⅜″ to ¾″ from the first surface.

18. The circular saw bracket of claim 9, wherein the third surface is ¼″ to ⅜″ wide.

19. A method for mounting a circular saw, the method comprising the steps of:
a. mounting a circular saw bracket to a secure surface;
b. the circular saw bracket having:
i. a body;
ii. a ledge protruding outwardly from the body; and
iii. a lip protruding upwardly from the mount; and
c. placing the circular saw onto the bracket,
wherein an upper blade guard of a circular saw rests upon the mount, and wherein the lip prevents engages an inside surface of the upper blade guard to prevent the circular saw from falling.

20. The method for mounting a circular saw of claim 19, wherein the circular saw is a handheld, electric powered, circular saw.
